(19) United States
(12) Patent Application Publication
(10) Pub. No.: US 2018/0064124 A1
(43) Pub. Date: Mar. 8, 2018

(54) APPARATUS AND METHOD FOR EXTENDING SHELF LIFE OF A FOOD PRODUCT COMPRISING WATER AND SOFT TISSUE

(71) Applicant: OPTIFREEZE AB, Lund (SE)

(72) Inventors: Eda Demir, RØDOVRE (DK); Pär Håkan Henriksson, LUND (SE); Katarzyna Dymek, LUND (SE); Federico Gomez, LUND (SE); Ingegerd Sjöholm, LUND (SE)

(21) Appl. No.: 15/559,622

(22) PCT Filed: Mar. 18, 2016
(86) PCT No.: PCT/SE2016/050227

§ 371 Date: Sep. 19, 2017

(30) Foreign Application Priority Data
Mar. 20, 2015 (SE) 1550335-2

(51) Int. Cl. A23B 7/015; A23B 7/055; A23B 7/08

(52) U.S. Cl. CPC A23B 7/015; A23B 7/055; B65B 25/041; B65B 2220/24; A23B 7/08

(57) ABSTRACT

The present invention describes an apparatus or system for extending shelf life of biological soft tissue, the apparatus includes a holding means; means for introducing one or more cell protecting agents into the extracellular and intracellular space of the biological soft tissue; means for rinsing and means for extended cold storage intended for preservation. Moreover, the present invention also relates to a method for extending shelf life of biological soft tissue, the method includes the steps of introducing one or more cell protecting agents into the extracellular and intracellular space of the biological soft tissue; and extended cold storing of the biological soft tissue intended for preservation of the same; and wherein the method also includes rinsing the biological soft tissue before or after the introducing of one or more cell protecting agents into the extracellular and intracellular space of the biological soft tissue.

### FIELD OF THE INVENTION

The present invention relates to an apparatus and a method for extending shelf life of biological soft tissue, e.g. in a food product comprising water and soft tissue.

### TECHNICAL BACKGROUND

There are existing methods for storing food known today. For instance, in WO2009/045144 there is disclosed a freezing method for a plant food product comprising the steps of; providing a plant food material comprising at least 70% water, applying a pulsed electrical field to said plant food material, adding a cryoprotective agent to said plant food material, applying a pressure to said plant food material followed by, a resting period of at least 30 minutes and freezing said plant food material.

Moreover, in CN101946848B there is disclosed a process involving cleaning and cutting apricots along the line to remove apricot seeds to obtain apricot flesh, placing this apricot flesh upward, blanching by flowing hot steam, then preparing sucrose sugar solution and dipping into sugar solution, performing pulsation by placing in a pulsating vacuum device, draining the sugar solution from the surface of the apricot flesh, washing with clean water, drying the apricot in a dry box by injecting a stream of gas to obtain dried apricot, and finally cooling to room temperature and packing.

One aim of the present invention is to provide an apparatus and a method for extending shelf life of a food product comprising water and soft tissue. The apparatus/system and method are directed to providing an improvement to existing technologies in terms of inter alia efficiency, energy consumption and user-friendliness.

### SUMMARY OF THE INVENTION

The stated purpose above is achieved by an apparatus for extending shelf life of biological soft tissue, said apparatus comprising:
a holding means;
means for introducing one or more cell protecting agents into the extracellular and intracellular space of the biological soft tissue;
means for rinsing; and
means for extended cold storage intended for preservation.

The expression “extended cold storage intended for preservation” implies applying a cold chain, during the treatment, which preferably is never broken. The shelf life of the tissue is extended by using the apparatus according to the present invention. Means for the extended cold storage according to the present invention may e.g. comprise a fridge and a storage room.

The expression “introducing” has several synonyms with respect to the present invention, e.g. infusing.

According to the present invention there are many different types of cell protecting agents possible to use. Naturally occurring safe ingredients or substances which have a water holding capacity is a potent example to employ according to the present invention. Examples are proteins and carbohydrates. Some examples of carbohydrate solutions are such containing trehalose, mannitol, fructose, glucose or sucrose, glycerol or any mixture thereof.

As notable from above, the present invention provides an apparatus for performing the method according to the present invention. This is one difference when comparing the present invention with WO2009/045144. Another important difference is the steps of the method as such. The present invention involves a cooling step and not a freezing step such as described in WO2009/045144. Moreover, the method according to WO2009/045144 is directed to involving a resting step before the freezing step, which is another difference when comparing with the present invention. The present invention has the advantage that a resting step is not needed when performing the method. There are also other important differences when comparing the present invention with WO2009/045144, which will be evident from the description below. One example is the fact that the present pre-treatment method according to the present invention preferably is keeping the cold chain through the entire process, which is not the case with the method according to WO2009/045144.

Furthermore, CN101946848B discloses a method which involves different process alternatives, such as cleaning, cutting and washing. The present invention, however, discloses an apparatus for extending shelf life of biological soft tissue which comprises means for introducing one or more cell protecting agents into the extracellular and intracellular space of the biological soft tissue; means for rinsing; and means for extended cold storage intended for preservation.

### BRIEF DESCRIPTION OF THE DRAWINGS

FIG. 1 shows the time and pressure protocol for one type of vacuum impregnation performed according to the present invention.

FIG. 2 shows the time and pressure protocol for another vacuum impregnation loop according to the present invention.

FIG. 3 shows the time and pressure protocol for yet another vacuum impregnation loop according to the present invention.

FIG. 4 shows a shelf life improvement test of spinach leaves where the weight loss is measured and compared between control leaves and leaves treated according to the present invention.

FIG. 5 shows an apparatus system for extending shelf life of a food product comprising water and soft tissue according to one embodiment of the present invention.

FIG. 6 shows the time and pressure vacuum impregnation protocol for spinach and rucola from additional trials.

### SPECIFIC EMBODIMENTS OF THE INVENTION

Below some specific embodiment of the present invention will be disclosed and discussed.

According to one specific embodiment of the present invention, the biological soft tissue is an edible plant tissue. It should, however, be noted that also other type of tissue may be possible to use.

Furthermore, the holding means of the apparatus according to the present invention may be of different type, e.g. a batch system, such as a container, or a continuous flow system. Batch systems are discussed further below. Regarding flow systems, then one example is to use a tank connected to a continuous flow system.

According to one specific embodiment of the present invention, means for introducing one or more cell protecting agents into the extracellular and intracellular space of the biological soft tissue, e.g. being a food product, includes an aqueous bath comprising the one or more cell protecting agents.

Suitably the container is immersed in the aqueous bath. One possible arrangement is with a perforated container being immersed in the aqueous bath, for instance within a tank, such as a vacuum tank when vacuum impregnation is employed. This is further explained below. Another possibility is to use a different tank for the aqueous bath but where there is a connection between this tank and the holding container. Another example is to use the container as such as the tank holding for the aqueous bath.

The aqueous bath holds the one or more cell protecting agents in a controlled concentration for employing the method according to the present invention.

According to yet another specific embodiment, wherein the apparatus also comprises means for impregnation. According to one specific embodiment of the present invention, the means for impregnation includes means for controlling the pressure being applied. According to the present invention both the use of a positive pressure and/or a negative pressure is possible. The feature of affecting/controlling the pressure relates to providing a change in pressure being applied. According to one embodiment, the means for impregnation includes means for vacuum impregnation, which implies using a negative pressure.

According to yet another specific embodiment of the present invention, the apparatus also comprises PEF (pulsed electric field) means. The PEF means may be of any conventional type, such as comprising different types of electrodes in different types of arrangements. According to one alternative of the present invention, the actual method being employed comprises both vacuum impregnation and application of a PEF.

As understood from above, the apparatus according to the present invention is directed to treating a biological soft tissue, such as e.g. a food product comprising water and soft tissue. In virtue thereof it may be of interest to affect the water content of the food product. Therefore, according to one embodiment of the present invention, the apparatus also comprises drying and/or dehydrating means. In relation to this it may be mentioned that drying implies removing water from a product to a certain extent, and dehydration is a more controlled process at a certain temperature and at certain humidity. The means of drying or dehydrating may comprise a regular dryer and/or dehydrator or a combination thereof. Any type of heating unit, e.g. microwave heating, light heating etc., may be applied according to the present invention. When dehydration is performed this should be performed before immersion/infusion, however if drying is employed this should be performed after the actual treatment. Furthermore, and as further disclosed below, if a dehydrating step is involved this may be performed before the infusion of the solution of the cell protecting agent(s), but can also be performed after the cycle of impregnation and PEF treatment, when being applied. In the latter case this is performed just before the cooling step according to the present invention.

Furthermore, the temperature is one important parameter when performing a method according to the present invention. Depending totally on the application and tissue material and cell protective solution being used, it can be of interest to be able to both increase the temperature during some steps as well as further decrease the temperature during other steps, not only during the actual cooling cycle. Based on the description above, according to one embodiment of the present invention, the apparatus also comprises heating means intended for temperature control. According to yet another embodiment, the apparatus also comprises cooling means intended for temperature control. These additional means for affecting the temperature may change the temperature in the container directly, implying that the temperature can be controlled during the entire method being performed. The cooling means being used for the actual cooling step being performed last before packaging may also be performed in the container, but can also be performed in another vessel or the like. In such a case the apparatus is more of a system comprising several units for performing the method.

Temperature, but also pressure, are important parameters. Therefore, according to one specific embodiment of the present invention, the apparatus also comprises a temperature controlling means and/or pressure controlling means. Such controlling means has the properties of both being able to measure and regulate the temperature and/or pressure and the rate of rise and/or fall of temperature and/or pressure to produce a specific profile over time.

The apparatus according to the present invention may also involve other means. One such possible add-on is shaking means, such as e.g. an ultrasonic bath, to remove air bubbles on the surface of the food product. This is further discussed below.

According to yet another embodiment, the apparatus also comprises means for measuring impedance. The impedance is measured in both the solid part of the tissue and in the liquid (liquid in the water bath) prior to, during or after treatment by the PEF means. This measurement could function as a quality or control measurement of the production as the level of impedance in the sold part and in the liquid should stay close to each other when performing a PEF treatment to ensure a uniform electrical field. The actual measurement can be performed by analysis of the pulse shape or by applying a certain frequency or scan.

The apparatus according to the present invention may further comprise other additional means. As mentioned, the apparatus also comprises means for rinsing. Rinsing or washing should be made before the active treatment according to the present invention. Rinsing may be performed by use of e.g. water but can also be performed by the PEF treatment as such. Rinsing can be performed as the last step, but can also be performed within a sequence of steps.

According to yet another specific embodiment of the present invention, the apparatus also comprises means for light treatment, e.g. UV treatment, or treatment with blue or red light or other light treatment. UV treatment may be performed for hygienization, and it may be employed before or after the impregnation. UV treatment may e.g. be performed by applying flashing or constant UV light.

The present invention also relates to a method for extending shelf life of a biological soft tissue, said method comprising the steps of:
introducing one or more cell protecting agents into the extracellular and intracellular space of the biological soft tissue; and
extended cold storing of the biological soft tissue intended for preservation of the same;
   and wherein the method also comprises rinsing the biological soft tissue before or after the introducing of one or more cell protecting agents into the extracellular and intracellular space of the biological soft tissue.

According to one embodiment of the present invention, the method also comprises impregnating the biological soft tissue, e.g. edible plant tissue, which step comprises controlling the pressure applied to the biological soft tissue when being immersed in an aqueous bath comprising the one or more cell protecting agents.

As mentioned above with reference to the apparatus, according to one specific embodiment of the present invention, impregnating the biological soft tissue comprises controlling the pressure applied to the biological soft tissue This may be either applying a positive pressure or a negative pressure in comparison with a starting pressure. According to one specific embodiment, impregnating the biological soft tissue comprises applying a vacuum to the biological soft tissue and then releasing the vacuum applied. The change of pressure may be performed at a specific gradient, both when applying the vacuum and when releasing the same. This is also the case if an overpressure is used instead of vacuum. The pressure level needed according to the present invention depends on the material to treat.

As hinted above, the tissue treated may be of any type, e.g. an edible plant tissue.

If vacuum impregnation is employed according to the present invention the time used may vary, such as e.g. in the range of 30 s-120 min, such as in the range of 10-120 min. Moreover, also the magnitude of the vacuum may vary, such as hinted above, e.g. in the range of 1000-15 mbar (absolute pressure).

According to yet another specific embodiment of the present invention, the method also comprises applying a PEF (pulsed electric field) to the biological soft tissue. Different alternatives and protocols are further discussed below.

Also other additional steps are possible, such as shaking to remove air bubbles on the surface of the food product. This may be executed by e.g. using a sonic bath. The parameters range may e.g. be in the range of 0-60 minutes at a frequency of 0-100 kHz at around room temp. If a higher frequency is used it can also be used to kill bacteria on the surface of the leaves without heating the acutal leaves as it will bounze on the surface.

Besides such possible extra steps, also other steps are possible. According to one specific embodiment, the method also comprises drying and/or dehydrating the biological soft tissue prior to, during or after introducing one or more cell protecting agents into the extracellular and intracellular space of the biological soft tissue. A dehydration operation may be executed before immersion and infusion.

In relation to the possible use of drying and/or dehydration steps according to the present invention EP 2151167 B1 may be mentioned. In EP 2151167 B1 there is disclosed a process for the production of frozen foods, particularly vegetables or fruits, said process involving subjecting the food to a dehydration treatment to partially eliminate the water content of the food, especially of its envelopment or of its outermost layer, by between 2% and 10% by weight; allowing the food to rest in a cold room to favour the redistribution of the free water contained therein; and once the free water contained in the food has been redistributed, subjecting the food to a rapid convection freezing treatment, wherein the dehydration treatment is carried out by convection by means of blowing of humid but non-saturated air at a temperature less than 15° C. As notable from the description above, EP 2151167 B1 is directed to freezing the material by use of convection. Furthermore, also EP 2151167 B1 involves a resting step just as WO2009/045144.

Besides the possible steps above the present invention may also comprise packaging the biological soft tissue before cooling the same. To describe one possible full cycle according to the present invention, a raw material is first washed and then exposed to a drying and/or dehydrating operation. Then a cell protecting agent is introduced into the intracellular space of the food product. After that the food product is impregnated, e.g. vacuum impregnated. A PEF treatment is performed simultaneously as the impregnation or performed immediately before, during or after the impregnation. Then a drying step may once again be performed. After PEF treatment and before packaging for cooling or without packaging for cooling, drying may be of interest to employ. The cooling step is performed as the last active treatment step before packaging the final treated tissue, e.g. the food product.

To disclose one possible method loop according to the present invention this loop may be as follows. First raw material arrives in a container, and is either washed on site or before. Based on this, according to one specific embodiment of the present invention, the method also comprises rinsing the food product before introducing one or more cell protecting agents into the intracellular space of the food product. Then, optionally a dehydration operation is performed. For hygienization, the method according to the present invention may also comprise heat treating, such as with light treatment, e.g. with UV treatment of the food product. If employed this is performed before impregnation.

Then vacuum impregnation is performed, possible also by use of an ultrasonic bath. Then PEF treatment is applied, either with a cycle overlapping the vacuum impregnation or directly afterwards. Then the material may be run through an operation involving a conveyor shaker or air dryer. Then the cooling step involving temperature in the range of −10-10° C. is employed without any preceding resting period. It should be noted that vacuum impregnation and PEF treatment might be done at the same time in the same treatment chamber. Moreover, another unit operation involving “degasifying” might be installed to avoid air bubble problem in case vacuum impregnation and PEF is done at the same time.

When comparing with WO2009/045144 or EP 2151167 B1 it should once again be noted that a resting step as an active treatment step is not needed according to the present invention.

As hinted above, the method may also comprise controlling the temperature of the biological soft tissue before or during impregnating and/or applying a PEF. The temperature and/or pressure may be controlled during the step(s) of impregnating and/or applying a PEF according to the present invention. For instance to measure and regulate the temperature at the PEF treatment may be of interest as there is a risk that the temperature increases during this treatment, specifically if the impedance of the food product is low. It should be noted that this possible increase in temperature may be of interest sometime to increase the effect of the PEF treatment.

According to one specific embodiment of the present invention, the steps of impregnating and applying a PEF are performed sequentially, however also simultaneously is fully possible. In relation to the latter alternative it should be mentioned that the expression “steps” imply the cycle of an operation, so in this case the cycles of impregnating and applying a PEF are overlapping. For instance if vacuum impregnation is used according to the present invention then the PEF treatment is performed when the vacuum is released, thus the cycles are overlapping but not all of the two different cycles are performed simultaneously. Therefore, according to one embodiment of the present invention, the step of impregnating implies applying vacuum to the biological soft tissue and the step of applying a PEF is performed during the time when pressure is increased when vacuum is released. According to one embodiment, applying a PEF is performed synchronized with the applied pressure.

Furthermore, according to yet another specific embodiment, applying a PEF is performed synchronized with the applied pressure. The synchronization may be employed in many different ways according to the present invention.

According to yet another embodiment, impedance is measured in biological soft tissue prior to, during or after applying a PEF to the food product. One possible example is to measure the actual conductivity, for instance by analysis of the pulse shape or to use a frequency sweep. As mentioned above, the impedance should be held at a reasonable closed level when comparing the solid part and the liquid in the water bath, and if not this can e.g. be regulated with ions. To measure the impedance may be of interest to enable adjustment of the conductivity and the pulse properties.

According to yet another embodiment of the present invention, the cooling step is performed at a temperature in the range of from −10 to 10° C. In relation to this range several aspects may be mentioned. First of all, the solution used may not only contain water, but e.g. a sugar solution and then the freezing temperature may be below 0° C. Secondly, also the food product as such does not only contain water, but may contain carbohydrates, salts etc., and therefore the freezing point of the food product may be below 0° C. Furthermore, supercooling or undercooling, which is a process of lowering the temperature below its freezing point without becoming a solid, is possible to employ according to the present invention. In relation to the above described it may be mentioned that some vegetables (such as garlic, shallots and peppers) can be stored at temperatures significantly below their freezing point (as low as −10° C. for some products) for weeks without freezing occurring. This phenomenon may also be referred to as supercooling and it occurs when the temperature of a solution or food material is reduced below its freezing point without ice crystallization, due to an energy barrier that must be surmounted before nucleation starts. When ice crystallization begins the temperature is raised to the freezing point. The point at which nucleation is initiated may be referred to as the ‘nucleation point’ or ‘metastable limit temperature’. Some vegetables (such as garlic, shallots and peppers) can be stored at temperatures significantly below their freezing point (as low as −10° C. for some products) for weeks without freezing occurring. This phenomenon has implications in chilled and super-chilled products.

According to one specific embodiment of the present invention, the cooling step is performed at a temperature in the range of 2-10° C., e.g. in the range of 2-6° C., which would be typical for a water solution, and when supercooling is not employed.

As said above, impregnation and application of PEF can be performed in different ways. According to one specific embodiment, the step of impregnating the biological soft tissue is performed during from 2 to 5 cycles. As should be understood from above, also using only one cycle is fully possible according to the present invention. According to another embodiment, the step of applying a PEF (pulsed electric field) to the biological soft tissue is performed by applying a certain number of pulses. In relation to this it may be mentioned that also one pulse may in fact comprise many sub-pulses. The actual time duration of the sub-pulses and also the time between the pulses may vary and affects the general PEF operation. According to one specific embodiment, the step of applying a PEF (pulsed electric field) to the biological soft tissue is performed by applying one or more pulses with a pulse width of from 10 ns to 1 ms. As an example a train of a number of pulses with a duration of typically between 10 ns and 1 ms, e.g. around 100 ns, may be applied. It is also a train of these so called nanopulses that will be experienced as one single pulse by the biological soft tissue, e.g. edible plant tissue, to treat. This may have a benefit as energy is saved and the risk for applying unwanted heat is also decreased.

In relation to the pulse width it should be mentioned that using pulses having a width of nanoseconds is what the technology of today allows. The present invention is not limited to such levels as such so in the future when the technology allows even faster/shorter pulses then also such may suitably be employed in the method according to the present invention.

As said, the number of pulses and pulse width etc. may vary. As an example it can be mentioned that a suitable pulse width is in the range of 10 ns-1 ms, a suitable pulse space should be minimum two times more than pulse width and as such in the range of 20 ns-4 ms, the number of pulses may e.g. be in the range of 1-990, the number of pulse trains may be in the range of 1-1000 and the space between the trains may be in the range of from 1-20 s. Pulse space may be minimum two times more than the pulse width in micro second pulse range. Pulse space may be the same or more than pulse width in nano s pulse range.

The field strength has to be selected based on the typical cell size of the product to be treated. If the resulting voltage over a single cell is above 1.5 V, the electroporation is non-reversible and the cell will probably die. The voltage shall therefore be selected to obtain a voltage below 1.5 V over a single cell to prevent cell denaturation but high enough to obtain a reversible electroporation. As an example typically 0.7-1.3 V is used over a single cell.

Another parameter is the choice of cell protective agent and also the concentration thereof. As mentioned, many different types of agents and solutions of different agents may be used. Protein and carbohydrate solutions are examples of high interest, especially solutions containing carbohydrates.

Some examples are sucrose, trehalose, fructose, glucose and/or mannitol. In the case of trehalose, which is a very potent choice for the cell protective agent, the maximum solubility of trehalose is 68.9 g/100 g H₂O at 20° C., and the concentration may be held at any level below this point in a aqueous solution. A suitable operation range is 1-40 g sucrose/100 g H₂O, such as 10-40 g sucrose/100 g H₂O. In the case of sucrose the maximum solubility of sucrose is 66.7 g/100 g H₂O at 20° C., and for mannitol it is 18.2 g/100 g H₂O at 20° C., and suitable concentration ranges may be found below these points.

### EXAMPLES

Shelf Life Improvement Tests with Spinach

Spinach is a leafy vegetable that can lasts for 5-7 days in unopened pack in a refrigerator. If the pack is opened, the spinach can last for 3-5 days in refrigerator. The usual way of packing fresh spinach leaves is in sealed plastic (perforated or not) bags of 60 g-500 g. The aim of the tests performed was to evaluate the possibility to extent shelf life of spinach with a pre-treatment or combination of pre-treatments according to the present invention.

The common traits of bad, rotten or spoiled spinach are a strong smell, darkened colour and a moist texture. Therefore the quick evaluation of this test was made based on sensory analysis.

### Materials and Methods

Raw Material: Spinach (Cultivar: Misano F1) leaves were harvested from the green house at Biology department, LU, on Nov. 21, 2014.

### Treatments

### Vacuum Impregnation (VI) According to Protocol No 1

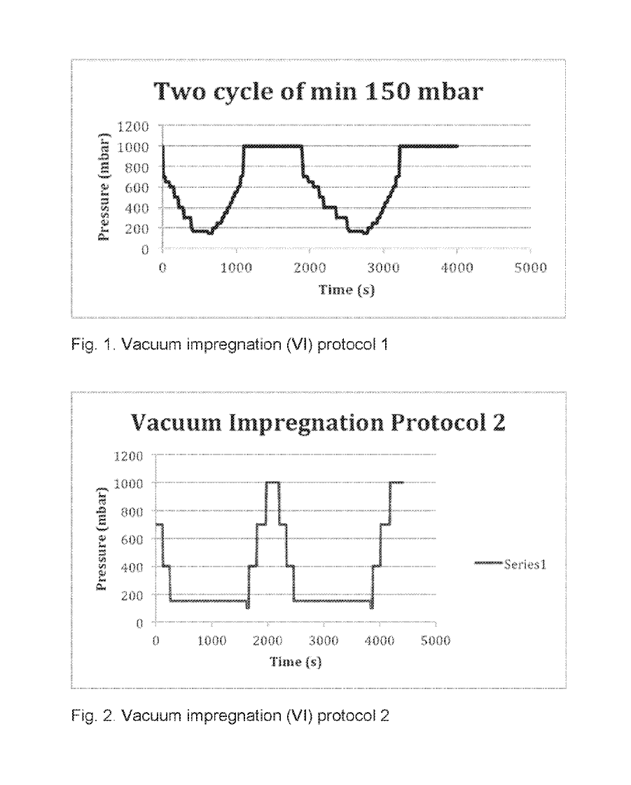

The VI treatment was carried out at 20° C. in a chamber connected to a vacuum pump. The spinach samples were immersed in 11% (w/v)(isotonic solution) and 20% (w/v) (hypertonic solution) solution of trehalose. Vacuum impregnation was completed in 65 min with two cycles of minimum 150 mbar pressure. The pressure inside the vacuum chamber was gradually decreasing from atmospheric pressure (1000 mbar) down to 150 mbar in 11 min, kept at 150 mbar for 1 min, gradually increased to atmospheric pressure for 7 min and kept at atmospheric pressure for 13 min. The cycle was repeated immediately and automatically as set in the programme of the vacuum controller. The vacuum protocol is displayed in FIG. 1 of the drawings.

The leaves were weighed before and after the treatment at room temperature. Weight gain of the leaves from vacuum impregnation was 39.9±3.6% in 11% trehalose solution and 16.9±9.6% in 20% trehalose solution.

### Vacuum Impregnation (VI) According to Protocol No 2

Vacuum impregnation was completed in 67 min with two cycles of minimum 150 mbar pressure. The vacuum was gradually increasing from 1000 to 150 mbar in 4 min, kept at 150 mbar for 20 min, gradually decreased to atmospheric pressure in 3 min and kept at atmospheric pressure for 3.5 min. The cycle was repeated immediately and automatically as set at the vacuum controller. The cycle does not necessarily have to be repeated. In that case the VI could be completed in 33.5 min, however the number of uniform infused leaves will decrease from. (2 cycles=85% of the leaves would be infused with solution, 1 cycle=55% of the leaves would be infused with solution).

The vacuum protocol 2 is displayed in FIG. 2.

### Pulsed Electric Field (PEF)

A mild PEF treatment was applied immediately after vacuum impregnation at room temperature. PEF parameters were optimized such that the PI (propidium iodide) staining on the surface of the leaves was not even as though the leakage of intra cellular liquid was minimized. PI (propidium iodide) staining on nuclei is a standard method for evaluation the efficiency of PEF treatment. When the cell membrane disruption takes place, PI entres inside the cell and binds on DNA and give fluorescence, which can be observed under ifluorescence microscope.

The parameters combination was:
Field Strength=400 V/cm
Conductivity of the medium=40 μS/cm
Pulse width=200 μs
Pulse separation (space)=1600 μs
Number of pulses in a train=500
Number of trains=2
Separation between trains=10 s

The leaves treated with isotonic and hypertonic solution were treated with the same PEF parameter combination in less than a minute time frame/each leaf. All leaves were treated in the conductive medium at room temperature. Conductive medium was refreshed in each leaf.

The temperature was increasing during PEF.

### Combination of Treatments

Spinach samples were treated with a combination of VI and PEF according to protocol no 1 prior to storage in refrigerator. The temperature of the refrigerator was fluctuating between 5.9° C. to 6.3° C. The treated and control leaves were placed randomly in a clean fridge plastic bag, the bag was closed by folding it as the plastic bag was longer than needed. The plastic bags were immediately placed in the fridge without overlapping each other once the leaves placed in. The samples codes with explanation of treatments are listed below in table. 10 leaves were prepared for each treatment and control.

| The sample code | Treatment Description |
|---|---|
| Control 1 - C1 | Fresh, non treated leaves |
| Control 2 - C2 | Only VI treated leaves with 11% trehalose |
| | sol. (No PEF) |
| Treatment 1 - T1 | VI (11% trehalose sol.) + PEF |
| Control 3 - C3 | Only VI treated leaves with 20% trehalose |
| | sol. (No PEF) |
| Treatment 2 - T2 | VI (20% trehalose sol.) + PEF |

### Evaluation

The results were evaluated based on the appearance, smell and acceptance as a consumer perspective by three persons. At the 14^{th} day, three people who did not know the codes and the treatments were evaluated the results in terms of appearance, smell and preference.

### Results

The leaves were captured in the 1^{st}, 6^{th}, 8^{th}, 11^{th} and 14^{th} day. The control and treated leaves were placed at the same position in all pictures. The sample codes were only written at first picture. Each day, all samples were taken out on a clean paper tissue and captured with the date.

### Appearance

The C1 leaves were started to look dry, shrink and aged as from the day 6^{th}. C3 leaves were started to look a little bit dry as from the 8^{th} day while C2 leaves were getting dry as from day 11^{th}. T1 and T2 leaves looked dry, shrink and old on the day 14^{th}. At the 14^{th} day, while the best looking samples were from T2, the panellists were commented that T1, C3 and T2 were acceptable and they would put it in their salad.

It has to be reported as well that VI is causing the leaves become more transparent and darker. But the darkness is not on unappetizing level.

### Smell

As from the day 8, C1 had a strong and bad smell (like cut grass) until the end of storage time. This means non-treated control samples were looking old and smelling quite bad, which is not convenient to consume anymore. C2 had like fish smell as from the 11^{th} day. C3, T1 and T2 did not show and tendency to have a bad smell even at the 14^{th} day.

### Acceptance & Preference

From the day 6^{th}, fresh (non treated) samples lost the appetizing appearance and would not be preferred in comparison to other treated samples. At the 14^{th} day, panellists and I preferred T1 and T2.

### Taste

The spinach samples were tasted until the 8^{th} day by one person. Only vacuum impregnated and both VI and PEF treated leaves had a slightly sweeter taste possibly due to the trehalose. Trehalose is only conceived as having a sweetness of 45% as compared to sucrose. It is not likely adversely influencing the taste of spinach. Previous sensorial tests were proven that people are not likely to distinguish between treated and non-treated leaves taste under red light. After the 8^{th} day, the C1 samples smelled badly, unable to consume. On the 8^{th} day, when the non-treated control samples lost all the structure of freshness and good taste of spinach, other samples had the freshness and hardness of natural fresh spinach.

### Conclusion

In consideration of the results this far, VI and PEF treatments in combination facilitate an increase of the shelf life from 3-7 (opened pack) days to 11-14 (opened pack) days.

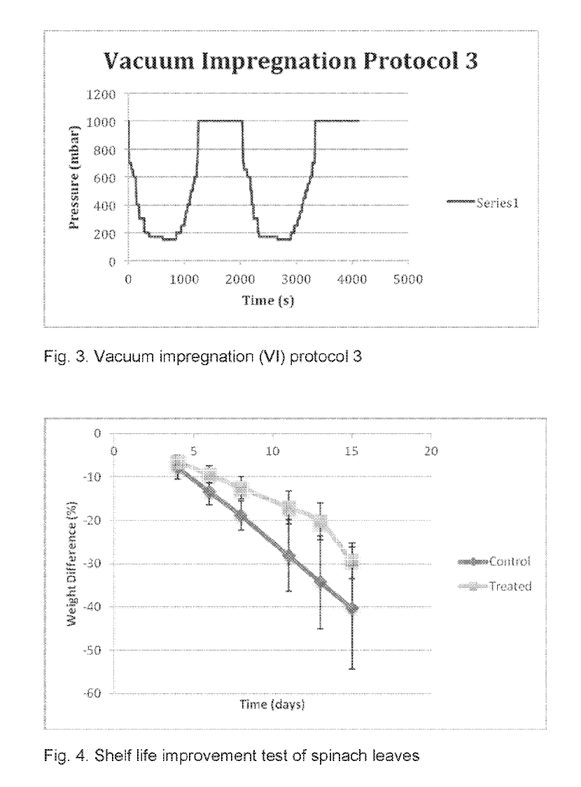

Moreover, yet another example of a time and pressure protocol for a vacuum impregnetion according to the present invention is shown in FIG. 3.

### Weight Loss Comparison

The method according to the present invention has also been validated by measuring the weight loss during a shelf life improvement test. Treated and untreated control spinach leaves (Winter Giant) were used in the test. 5 different series for both treated and control leaves were investigated. The treated spinach leaves were treated according to the present invention by vacuum impregnation in 20% trehalose solution according to protocol number 3 (see FIG. 3). The weight gain of the leaves was 17.6±8.0%.The leaves were immediately PEF treated with the same parameter as the first trial. The leaves were weighed starting from day 1 and the actual weight loss was calculated. In FIG. 4 it is shown that the weight loss of the treated leaves was less compared with the treated leaves. The comparison shows that the present invention facilitates a more efficient preservation. More of the material and cell structure is kept intact. The cell protecting agent, trehalose in this specific case, holds the natural liquid in the extra- and intracellular space of the tissue, and this renders holding the weight to a higher extent than in the control leaves. This is the reason why the drying time is extended in the treated leaves when comparing to the non-treated ones.

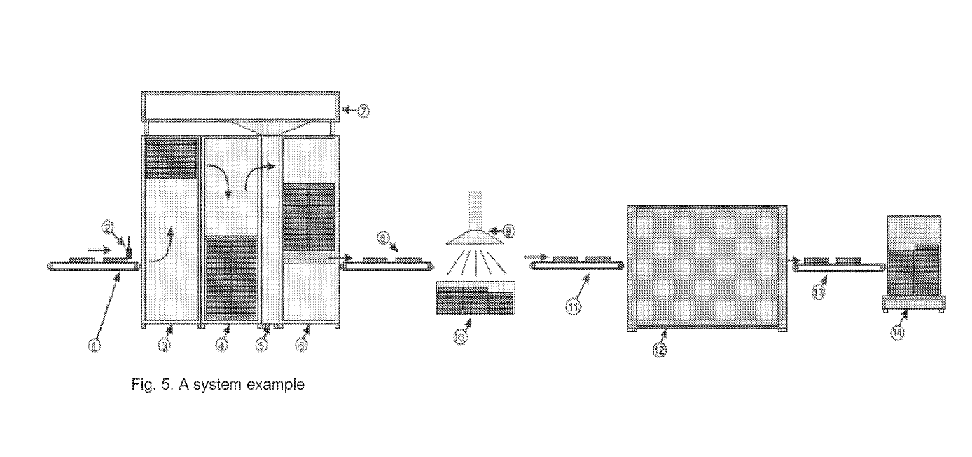

In FIG. 5 there is shown one example of an apparatus system for extending shelf life of a food product comprising water and soft tissue according to the present invention. The treatments may be performed in the batch systems connected with flow and a kind of stacking system that stacks up a number of product trays in a stack. The product comes on the left tray (1) into the apparatus and is rinsed off before entering the chamber to remove dirt using a rinse system (2). The trays are then stacked in a stacking system (3). The stack is moved through the entire stacking system into the infusion and treatment bath (4). In a separete module (5) where the pressure is managed in the processing chamber and the PEF pulses (electric field) are applied by a generator to the individual stacks that are immersed in the pressurized chamber. Here is also the mixer that mixes the proper blend of substance and water in the right proportion and at the right temperature.

After treating the whole stack of trays, subsequent rested stack of trays are lifted out to the dispenser (6) where the treated products can rest more. On top of the production line, an autocatalytic cassette (7) is inserted with the premixed substance composition. The products are moved via the conveyor belt (8) into the shaker chamber (10) to remove excess water which is supported with a dryer (9) to remove surface water of the product. The product trays are fed onto the conveyor belt (11) and fed to the freezer tunnel (12), and further via a further conveyor belt (13) product is moved to a product packer (14) in order to get a finished product.

### Further Trials

Rucola leaves which were not washed were used durig this further trial. Leaves were transported in the cooling boxes and immediately placed in a cold container. All the preparations were done in a cold container at 4° C. Leaves were immersed in cold tap water in order to wash out soil and other impurities.

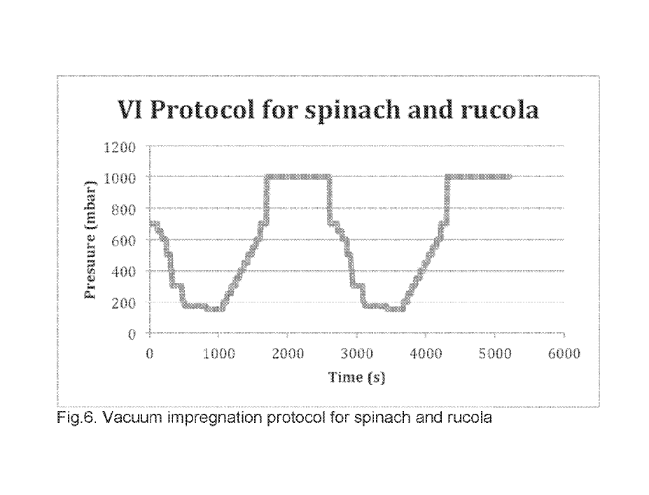

PEF was applied to the rucola leaves with the following parameters: 166 V/cm, 250 uS/cm medium conductivity, 125 us pulse duration, 1000 us space between pulses, 200 pulses. Leaves were PEFed in a big chamber (gen 2), placed randomly approx. 80 leaves per treatment.
Afterwards leaves were VI with the following cryoprotectants:
   1. Sucrose 18%
   2. Glycerol 5%
   3. Glucose 5%
VI protocols is shown in FIG. 6.
The leaves were placed in lunch boxes on a wet tissue and plastic net. The lunch boxes were placed at 4° C. overnight resting.
They were blotted with the tissue to dry the surface and placed in the ‘vegetable dryer’ for 5 min at 40° C. They were packed in bags made from microporated plastic foil. In relation to this, according to one specific embodiment, the packing is performed in microporated packages. Microporated materials may be of interest to use as these material are permeable.

| | Cryopro- | | |
|---|---|---|---|
| No. | tectant | 14 days | 21 days |
| 0 | Control | Strong smell, turgid | Strong smell, collapsed |
| | | structure, not collapsed, | structure, colour changed |
| | | many brown spots | to yellow. |
| 1 | Sucrose | No smell, turgid structure, | No smell, turgid |
| | | not collapsed, green | structure, not collapsed, |
| | | colour | green colour |
| 2 | Glycerol | No smell, turgid structure, | Artificial smell, turgid |
| | | not collapsed, few spoiled | structure, not collapsed, |
| | | leaves | few spoiled leaves |
| 3 | Glucose | No smell, turgid structure, | No smell, a bit collapsed |
| | | not collapsed, few spoiled | structure, few spoled |
| | | leaves | leaves |

1. An apparatus for extending shelf life of biological soft tissue, said apparatus comprising:
a holding means;
means for introducing one or more cell protecting agents into the extracellular and intracellular space of the biological soft tissue;
means for rinsing; and
means for extended cold storage intended for preservation.

2.-3. (canceled)

4. The apparatus according to claim 1, wherein the holding means is a continuous flow system.

5.-6. (canceled)

7. The apparatus according to claim 1, wherein the apparatus also comprises means for impregnation and wherein the means for impregnation includes means for vacuum impregnation, and/or wherein the apparatus also comprises PEF (pulsed electric field) means.

8. The apparatus according to claim 1, wherein means for introducing one or more cell protecting agents into the extracellular and intracellular space of the biological soft tissue includes an aqueous bath comprising the one or more cell protecting agents.

9.-15. (canceled)

16. A method for extending shelf life of a biological soft tissue, said method comprising the steps of:
introducing one or more cell protecting agents into the extracellular and intracellular space of the biological soft tissue; and
extended cold storing of the biological soft tissue intended for preservation of the same; and wherein the method also comprises rinsing the biological soft tissue before or after the introducing of one or more cell protecting agents into the extracellular and intracellular space of the biological soft tissue.

17. (canceled)

18. The method according to claim 16, wherein the biological soft tissue is also impregnated, which step comprises applying a vacuum to the biological soft tissue and then releasing the vacuum applied and/or wherein the method also comprises applying a PEF (pulsed electric field) to the biological soft tissue.

19.-20. (canceled)

21. The method according to claim 16, wherein the method also comprises drying and/or dehydrating the biological soft tissue prior to, during or after introducing one or more cell protecting agents into the extracellular and intracellular space of the biological soft tissue.

22.-25. (canceled)

26. The method according to claim 16, wherein the steps of impregnating and applying a PEF are performed sequentially.

27. The method according to claim 16, wherein the step of impregnating implies applying vacuum to the biological soft tissue and wherein the step of applying a PEF is performed during the time when pressure is increased when vacuum is released and/or wherein applying a PEF is performed synchronized with the applied pressure.

28.-29. (canceled)

30. The method according to claim 16, wherein the cooling step is performed to a temperature in the range of from −10 to 10° C.

31. The method according to claim 16, wherein the cooling step is performed to a temperature in the range of 2-10° C.

32. The method according to claim 16, wherein the step of impregnating the biological soft tissue is performed during from 2 to 5 cycles.

33. The method according to claim 16, wherein the step of applying a PEF (pulsed electric field) to the biological soft tissue is performed by applying a certain number of pulses.

34. The method according to claim 16, wherein the step of applying a PEF (pulsed electric field) to the biological soft tissue is performed by applying one or more pulses with a pulse width of from 10 ns to 1 ms.

35. The method according to claim 16, wherein rinsing the biological soft tissue is performed before introducing one or more cell protecting agents into the intracellular space of the biological soft tissue.

36. (canceled)
